(19) United States
(12) Patent Application Publication
(10) Pub. No.: US 2007/0046940 A1
(43) Pub. Date: Mar. 1, 2007

(54) Positioning system and method using displacements

(76) Inventors: Jun Gao, Palo Alto, CA (US); Carl E. Picciotto, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/209,084

(22) Filed: Aug. 22, 2005

(51) Int. Cl. G01B 11/00

(52) U.S. Cl. 356/401

(57) ABSTRACT

A method comprising capturing a first image that includes a target on a substrate, adjusting a first relative position between the substrate and a fabrication unit, capturing a second image that includes the target subsequent to adjusting the first relative position, and determining whether a first displacement of the target in the second image relative to the target the first image indicates that a second relative position between the substrate and the fabrication unit has been achieved is provided.

### BACKGROUND

Various systems exist for the purpose of positioning a substrate in one or more locations to allow patterns to be performed on the substrate. Some systems, such as alignment systems, attempt to position substrates by directly aligning one or more patterns on the substrates with the goal of a zero-length displacement. Moiré patterns or other particular patterns such as a box and a cross may be used for this purpose.

With existing alignment systems, the positioning of substrates may be poorly quantized and may not be useful in instances where a non-zero displacement is desired. In addition, the overlay of components of a fabrication system such a mask or a mold may not be possible. It would be desirable to be able to accurately quantize the position or positions of substrates.

### SUMMARY

One form of the present invention provides a method comprising capturing a first image that includes a target on a substrate, adjusting a first relative position between the substrate and a fabrication unit, capturing a second image that includes the target subsequent to adjusting the first relative position, and determining whether a first displacement of the target in the second image relative to the target the first image indicates that a second relative position between the substrate and the fabrication unit has been achieved.

### BRIEF DESCRIPTION OF THE DRAWINGS

FIG. 1 is a block diagram illustrating one embodiment of a fabrication system.

FIG. 2 is a flow chart illustrating one embodiment of a method for forming patterns on a substrate in a fabrication system.

FIG. 3A-3C are diagrams illustrating one embodiment of a method of forming patterns on a substrate.

FIG. 4 is a flow chart illustrating one embodiment of a method for forming patterns on a substrate in a fabrication system.

FIG. 5A-5D are diagrams illustrating one embodiment of capturing a target in images.

FIG. 6 is a flow chart illustrating one embodiment of a method for forming patterns on a substrate in a fabrication system.

FIG. 7A-7E are diagrams illustrating one embodiment of capturing a target in images.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

According to one or more embodiments, the systems and methods described herein provide a process by which a displacement sensing system may be used to provide accurately positioned placement of repeating patterns in fabrication processes. The repeating patterns may be duplicate device patterns distributed across a substrate (e.g., within multiple dice across a silicon wafer), or the repeating patterns may be inherent to a single, large, regular substrate such as a multi-pixel display. The fabrication process may be any step and repeat method, such as those involving photolithography (contact and non-contact), imprint lithography, laser direct-writing or lithography, e-beam direct-writing or lithography, x-ray lithography, or printing, such as via a thermal inkjet technology or piezoelectric inkjet technology or other types of non-impact printing. The fabrication process describes a multi-field process, involving individual pattern fields or regions which are smaller than the overall substrate.

According to one or more embodiments, a system and method for forming repeating patterns on a substrate are provided. The system and method include capturing a first image that includes a target on a substrate, adjusting a first relative position between the substrate and a fabrication unit, capturing a second image that includes the target subsequent to adjusting the first relative position, and determining whether a first displacement of the target in the second image relative to the target the first image indicates that a second relative position between the substrate and the fabrication unit has been achieved.

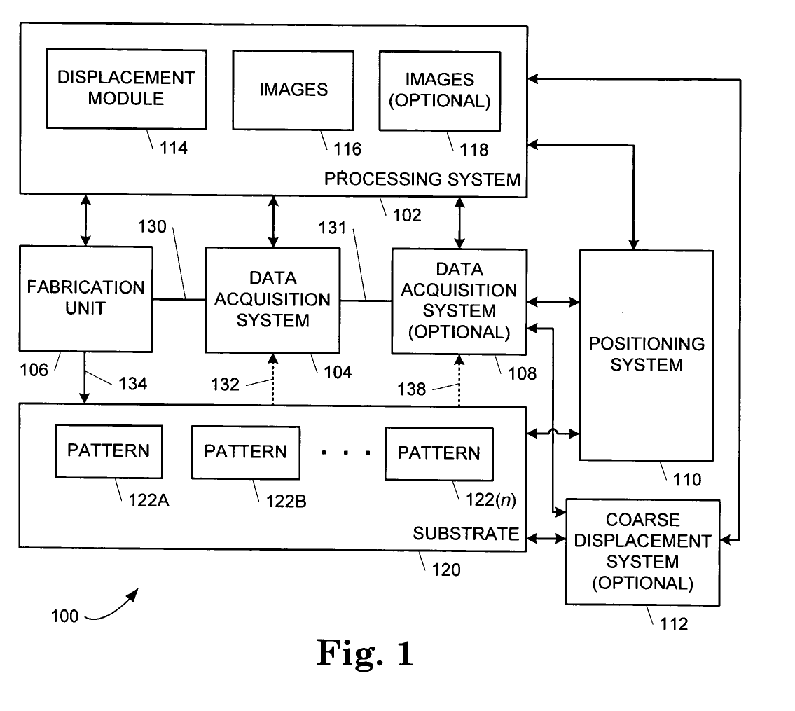

FIG. 1 is a block diagram illustrating one embodiment of a fabrication system 100. Fabrication system 100 includes a processing system 102, a data acquisition system 104, a fabrication unit 106, an optional data acquisition system 108, a positioning system 110, and an optional coarse displacement system 112. Fabrication system 100 operates on a substrate 120 to form pattern instances 122A through 122(n) (referred to individually as pattern instance 122 or collectively as pattern instances 122) where n is greater than one and represents the nth pattern instance.

Processing system 102 receives and stores images 116 from data acquisition system 104 and optionally receives and stores images 118 from data acquisition system 108. Processing system 102 processes images 116 and images 118 using a displacement module 114. Using displacement module 114, processing system 102 identifies or locates one or more targets (not shown) in images 116 or 118, and calculates displacements between the relative position of the targets in different images 116 or 118. Processing system 102 may calculate the displacements to a pixel or a sub-pixel resolution.

Displacement module 114 may embody any suitable algorithm for calculating displacements using images 116 and/or images 118. Suitable algorithms may include an image cross-correlation algorithm, a phase delay detection algorithm, or other displacement estimation algorithms.

With an image cross-correlation algorithm, displacement module 114 uses image cross-correlations to calculate the displacement. One example of an image cross-correlation algorithm is an N-cubed algorithm. The N-cubed algorithm analyzes image cross-correlations to determine displacements b directly locating a peak of a correlation surface to the nearest pixel, or by curve-fitting the correlation surface to a function (e.g., a simple second-order Taylor Series expansion function) and then determining the location of the maximum (or minimum) value to sub-pixel precision. The correlation function used in the N-cubed algorithm is defined by Equation I.

$${C}_{i , j}^{k} = {\sum }_{m = 1}^{M} {\sum }_{n = 1}^{N} {\vert {r}_{m , n} - {c}_{m - i , n - j} \vert}^{k} \qquad Equation 1$$

In Equation I, C_{i,j}^{k} is the correlation surface, r_{m,n} and c_{m,n} represent the two image frames (e.g., reference and comparison frames), and k is an exponent that is typically two. The correlation surface is fit to a curve, and the extremum of this curve (for the case of this correlation function, it is a global minimum point) is deduced, thereby determining the displacement vector to sub-pixel precision. Any function that results in an extremum at the point of closest image matching could be incorporated into such as scheme.

Another example of an image cross-correlation algorithm is a nearest neighbor navigation algorithm. With the nearest neighbor navigation algorithm, displacement module 114 uses image cross-correlations or comparison functions which approximate or parallel pixel-by-pixel correlation functions to calculate the displacement. The nearest neighbor navigation algorithm uses very short correlation distances in calculating the displacement. Additional details of nearest neighbor navigation algorithms may be found in U.S. Pat. No. 5,149,980 entitled “SUBSTRATE ADVANCE MEASUREMENT SYSTEM USING CROSS—CORRELATION OF LIGHT SENSOR ARRAY SIGNALS” listing Ertel et al. as inventors and U.S. Pat. No. 6,195,475 entitled “NAVIGATION SYSTEM FOR HANDHELD SCANNER” listing Beausoleil et al. as inventors. Each of these patents is assigned to the assignee of the present invention, and is hereby incorporated by reference herein.

With the phase delay detection algorithm (and other similar phase correlation methods) displacement module 114 processes images converted to a frequency domain representation and draws equivalences between phase delays and displacements to calculate the displacement.

Functions performed by processing system 102 and displacement module 114 may be implemented in hardware, software, firmware, or any combination thereof. The implementation may be via a microprocessor, programmable logic device, or state machine. Components of the present invention, e.g., displacement module 114, may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

Data acquisition system 104 includes any suitable optical or non-optical system configured to acquire data from substrate 120 to form one or more images 116 such that images 116 may be used to identify locations of one or more targets. Data acquisition system 104 is configured in a fixed location relative to fabrication unit 106 as indicated by an arrow 130. Examples of optical systems include a camera or other device configured to optically capture images 116. Examples of non-optical systems include electron beam devices or other devices configured to capture images 116 using non-optical means. Data acquisition system 104 has a resolution and a scale appropriate for the type of substrate 120. The resolution may be pixel, sub-pixel, or another suitable resolution, and the scale may be nanoscale or another suitable resolution. Images 116 include any set of optical or non-optical data that may be used to identify the locations of one or more targets.

In operation, data acquisition system 104 captures images 116 of substrate 120 that each image 116 includes at least one target as indicated by a dashed arrow 132 and provides images 116 to processing system 102.

Fabrication unit 106 includes any suitable patterning or imaging device that is configured to form patterns 122 on substrate 120 as indicated by an arrow 134. Fabrication unit 106 may include a photolithography unit (contact and non-contact), an imprint lithography unit, a laser direct-writing or lithography unit, an e-beam direct-writing or lithography unit, an x-ray lithography unit, or a printing unit, such as a thermal inkjet printer unit, a piezoelectric inkjet printer unit, or another type of non-impact printing unit, for example. Fabrication unit 106 is configured in a fixed location relative to data acquisition system 104 as indicated by arrow 130. Accordingly, fabrication unit 106 and data acquisition system 104 move in unison relative to substrate 120.

Optional data acquisition system 108 includes any suitable optical or non-optical system configured to acquire data from substrate 120 to form images 118 such that images 118 may be used to identify locations of one or more targets. Examples of optical systems include a camera or other device configured to optically capture images 118. Examples of non-optical systems include electron beam devices or other devices configured to capture images 118 using non-optical means. Data acquisition system 108 has a resolution and a scale appropriate for the type of substrate 120. The resolution may be pixel, sub-pixel, or another suitable resolution, and the scale may be nanoscale or another suitable resolution. Images 118 include any set of optical or non-optical data that may be used to identify locations of one or more targets. If present, data acquisition system 108 is configured in a fixed location relative to data acquisition system 104 as indicated by arrow 131. Accordingly, data acquisition system 108 and data acquisition system 104 move in unison relative to substrate 120.

In operation, data acquisition system 108 captures images 118 of substrate 120 that each image 118 includes at least one target as indicated by a dashed arrow 138 and provides images 118 to processing system 102. The functions of data acquisition system 108 may be performed by data acquisition system 104 in one or more of the embodiments described herein.

Positioning system 110 is configured to position substrate 120 relative to data acquisition system 104, fabrication unit 106, and data acquisition system 108 according to values determined by processing system 102. In one embodiment, position system 110 moves or otherwise adjusts the position of substrate 120 relative to data acquisition system 104, fabrication unit 106, and data acquisition system 108 according to values determined by processing system 102. In another embodiment, positioning system 110 moves or otherwise adjusts the position of data acquisition system 104, fabrication unit 106, and data acquisition system 108 relative to substrate 120 according to values determined by processing system 102.

Optional coarse displacement system 112 may be used if the distance between data acquisition system 104 and data acquisition system 108 is large to monitor the relative position between substrate 120 and data acquisition systems 104 and 108. Coarse displacement system 112 may be configured in an open loop configuration or a closed loop configuration with a feedback system (not shown).

Substrate 120 may be any suitable one, two, or three dimensional work object such as a silicon or other type of semiconductor wafer, paper, a display panel, and a web of material. The term “web of material” covers both a web of material that carries objects (e.g., a conveyor) and the surface of a work object that is moveable relative to fabrication system 100. Each pattern 122 comprises any feature or set of features that is formed on substrate 120.

Substrate 120 includes targets that are used by processing system to calculate displacements. Each target includes any feature or set of features that is formed or naturally occurring on substrate 120. The target may be naturally occurring on substrate 120 or man-made and may include broad-area features of substrate 120, whether the features cover a large or small area of substrate 120. The target may be created as a result of a fabrication process or produced concurrently to the use of this invention. The target may also be on the same surface of formed patterns 122 or a different surface, e.g., the backside surface of a silicon substrate where fabrication unit 106 forms patterns 122 on the frontside surface of the silicon substrate.

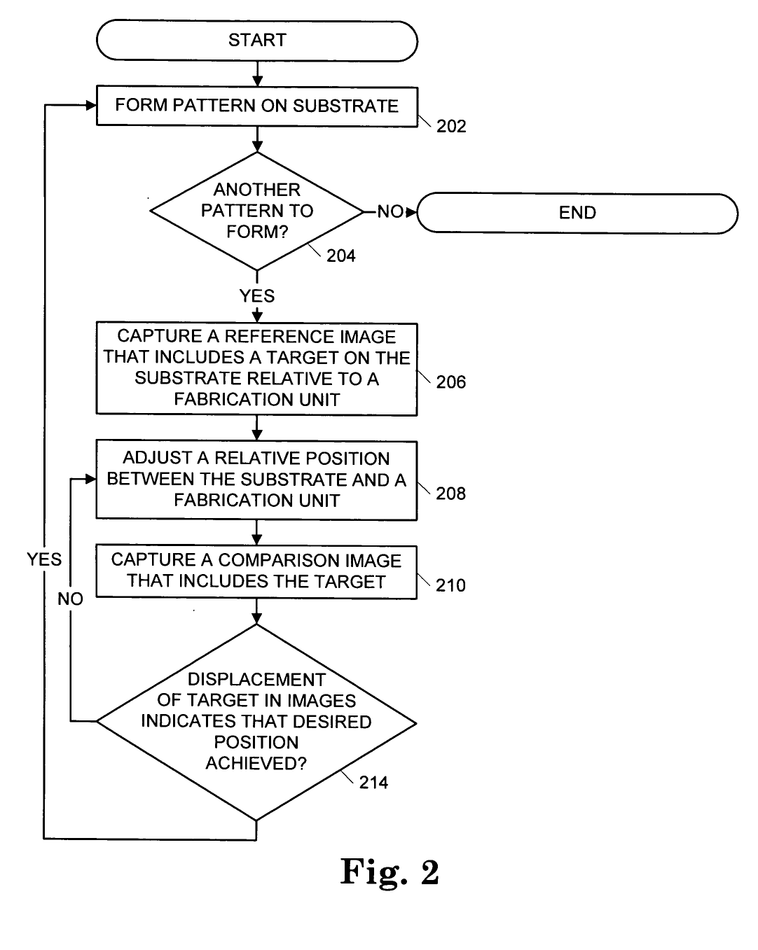

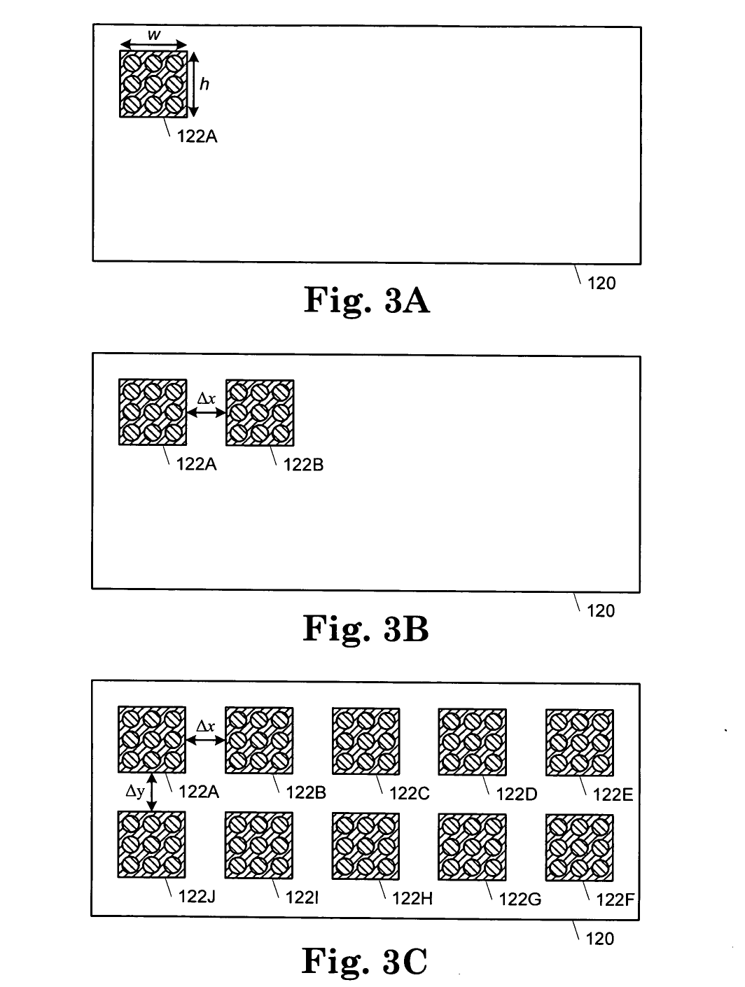

FIG. 2 is a flow chart illustrating one embodiment a method for forming patterns on substrate 120 in fabrication system 100. The method of FIG. 2 will be described with reference to fabrication system 100 as shown in FIG. 1 and examples of patterns 122 and substrate 120 as shown in FIGS. 3A-3C according to one embodiment.

In FIG. 2, fabrication system 100 forms a pattern 122 on substrate 120 as indicated in a block 202. In the example of FIG. 3A, fabrication unit 106 forms pattern 122A on substrate 120 at a desired location. Pattern 122A includes a width, w, and a height, h.

In other embodiments, pattern 122A may be formed on substrate 120 prior to commencing the method shown in FIG. 2. In these embodiments, the function of block 202 may be skipped in the first iteration of the method.

A determination is made by fabrication system 100 as to whether there is another pattern 122 to form as indicated in a block 204. If there is not another pattern 122 to form, then the method ends as shown. If there is another pattern 122 to form, then fabrication system 100 captures a reference image 116 that includes a target on substrate 120 relative to fabrication unit 106 as indicated in a block 206. As noted above, the target may be formed or naturally occurring on substrate 120. In the example of FIG. 3A, all or a portion of pattern 122A may be used as the target. Accordingly, data acquisition system 104 captures reference image 116 that includes all or a portion of pattern 122A on substrate 120 in the example of FIG. 3A.

Fabrication system 100 adjusts a relative position between substrate 120 and fabrication unit 106 as indicated by a block 208. By adjusting the relative position between substrate 120 and fabrication unit 106, fabrication system 100 also adjusts the relative position between substrate 120 and data acquisition system 104 and, if present, data acquisition system 108, because of the fixed position between fabrication unit 106, data acquisition system 104, and data acquisition system 108.

In one embodiment, positioning system 110 adjusts the relative position between substrate 120 and fabrication unit 106 by moving substrate 120 relative to data acquisition system 104, fabrication unit 106, and, optionally, data acquisition system 108 by a value determined by processing system 102. In other embodiments, positioning system 110 adjusts the relative position between substrate 120 and fabrication unit 106 by moving data acquisition system 104, fabrication unit 106, and data acquisition system 108 relative to substrate 120 by a value determined by processing system 102.

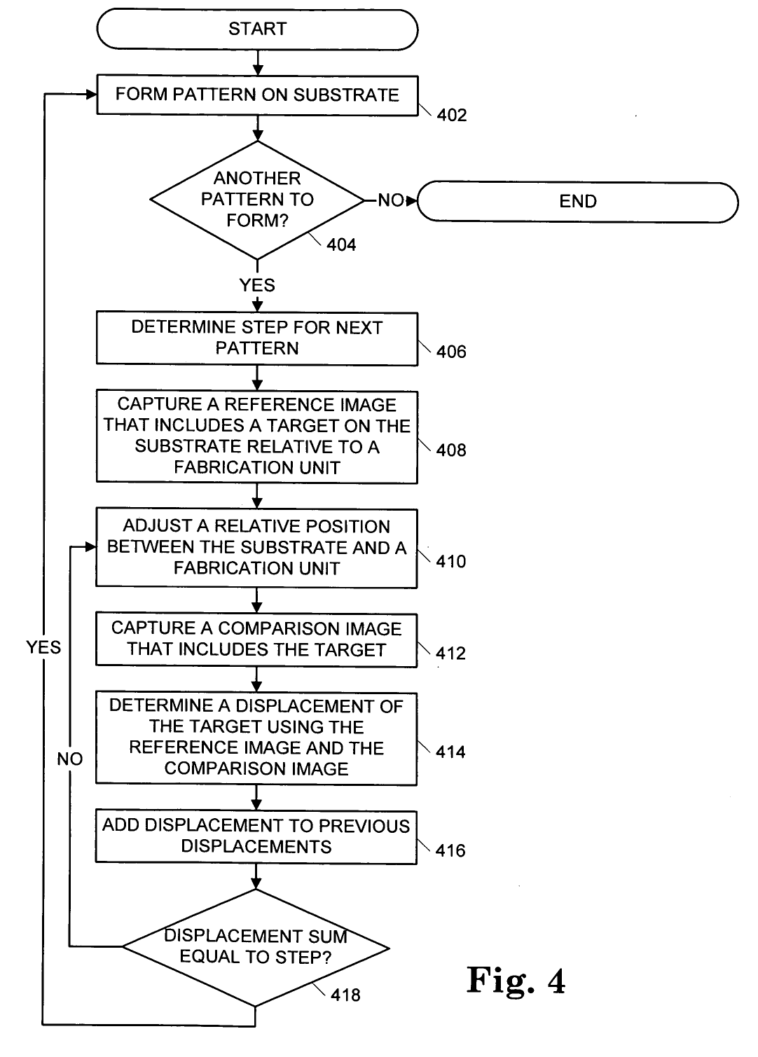

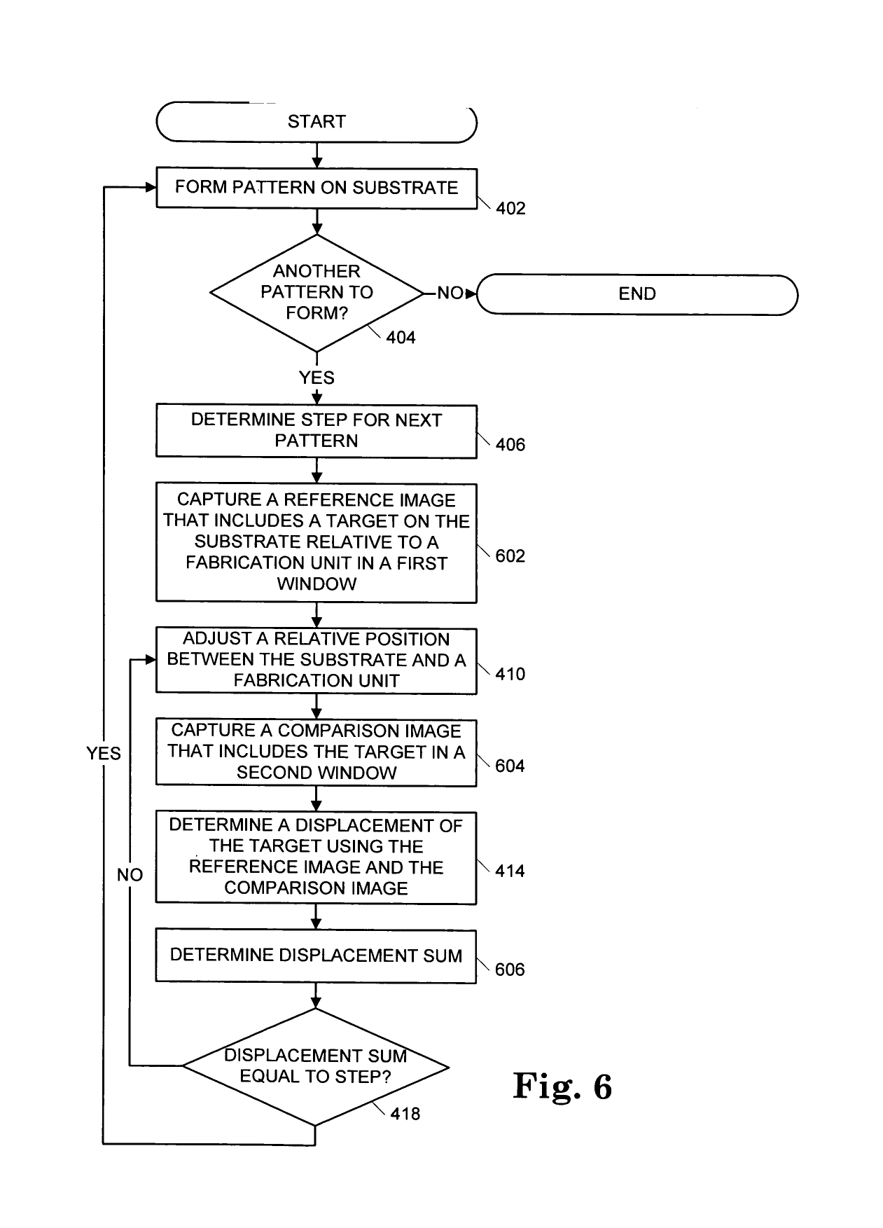

In one embodiment described in additional detail with reference to FIG. 4, each value used in adjusting the relative position between substrate 120 and fabrication unit 106 may cause the relative position between substrate 120 and fabrication unit 106 to be adjusted by a small fraction of a desired step, i.e., desired relative position between patterns 122 on substrate 120. In another embodiment described in additional detail with reference to FIG. 6, each value used in adjusting the relative position between substrate 120 and fabrication unit 106 may cause the relative position between substrate 120 and fabrication unit 106 to be adjusted by a distance between imaging windows of data acquisition system 104 and/or data acquisition system 108, where the distance is equal to the desired step, a sub-multiple of the distance, or a correction amount.

Subsequent to adjusting the relative position between substrate 120 and fabrication unit 106, fabrication system 100 captures a comparison image 116 or 118 that includes the target as indicated in a block 210. In the example of FIG. 3A, data acquisition system 104 or data acquisition system 108 captures comparison image 116 or 118 such that comparison image 116 or 118 includes all or a portion of pattern 122A on substrate 120.

A determination is made by fabrication system 100 as to whether a displacement of the target in reference image 116 and comparison image 116 or 118 indicates that a desired relative position between patterns 122 on substrate 120, i.e., a desired step, has been achieved as indicated in a block 214. In one embodiment, fabrication system 100 determines that the desired step has been achieved in response to determining that either the sum of the displacements from each iteration of performing the function of blocks 206 through 210 or the displacement itself is equal to the desired step.

If the desired step has not been achieved, then fabrication system 100 repeats the functions of blocks 208 through 212 until the desired step is achieved. In the process of repeating the functions of blocks 208 through 212, fabrication system 100 stores comparison image 116 or 118 for use as the reference image in the next iteration of performing the functions of blocks 208 through 212. Fabrication system 100 also stores each displacement or a sum of the displacements.

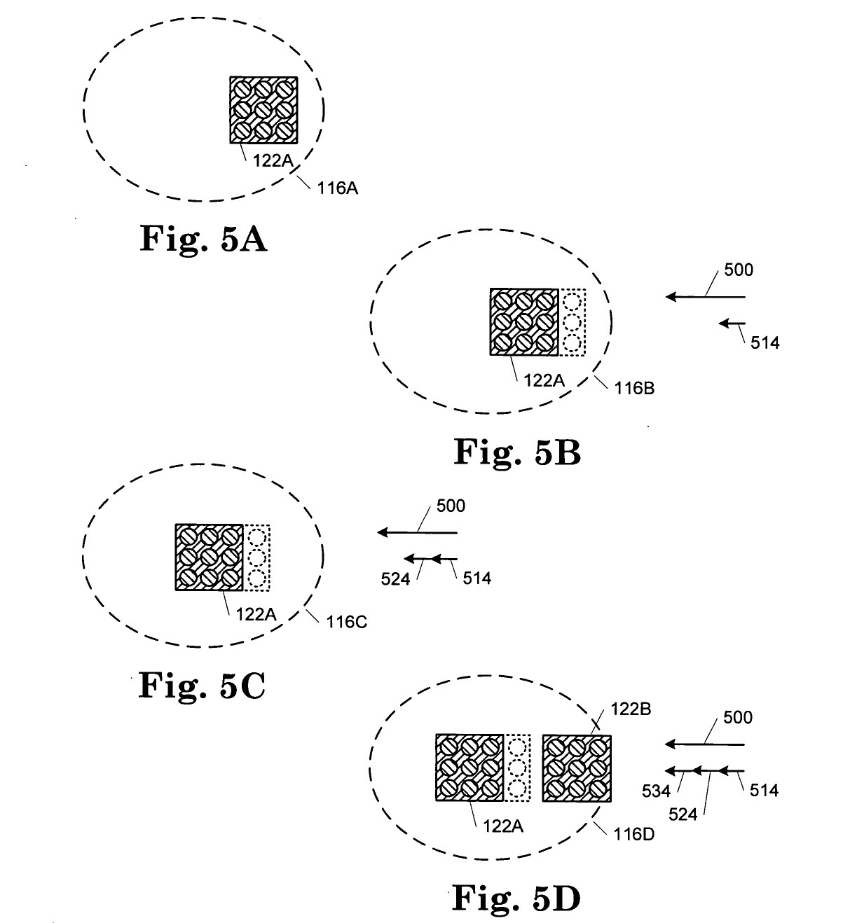

If the desired step has been achieved, then the method continues by repeating the functions of blocks 202 through 214 until there are no other patterns 122 to form. With each iteration of performing the function of block 202, fabrication system 100 forms a pattern 122 on substrate 120 at a desired step from a previous pattern 122. In the example shown in FIG. 3B, fabrication unit 106 forms a pattern 122B on substrate 120 where the desired step, Sₓ, between pattern 122A and pattern 122B is indicated by Equation II.
Sₓ=w+Δx Equation II
As shown in the example of FIG. 3C, fabrication system 100 continues to form patterns 122C-122J such that each pattern 122 is offset from a previous pattern 122 by Sₓ in the horizontal direction. In addition, fabrication system 100 forms patterns 122A-122J such that each pattern 122 is offset from a previous pattern 122 by a step S_{y}, where S_{y} is indicated by Equation III, in the vertical direction.
S_{y}=h+Δy Equation III
FIG. 4 is a flow chart illustrating one embodiment a method for forming patterns 122 on substrate 120 in fabrication system 100. The method of FIG. 4 will be described with reference to fabrication system 100 as shown in FIG. 1 and examples of a target, i.e., pattern 122A, in reference and comparison images as shown in FIGS. 5A-5D according to one embodiment. Data acquisition system 108 is not present or not used in the embodiment of the method of FIG. 4.

In FIG. 4, fabrication unit 106 forms a pattern 122 on substrate 120 as indicated in a block 402. In the example of FIG. 5A, fabrication unit 106 forms pattern 122A on substrate 120 at a desired location. In other embodiments, pattern 122A may be formed on substrate 120 prior to commencing the method shown in FIG. 4. In these embodiments, the function of block 402 may be skipped in the first iteration of the method.

A determination is made by fabrication system 100 as to whether there is another pattern 122 to form as indicated in a block 404. If there is not another pattern 122 to form, then the method ends as shown. If there is another pattern 122 to form, then processing system 102 determines a step for a next pattern 122 as indicated in a block 406. In the example of FIGS. 5A-5D, the step represents the desired displacement between pattern 122A and the next pattern 122B to be formed by fabrication unit 106 and is represented by an arrow 500.

Data acquisition system 104 captures a reference image 116 that includes a target on substrate 120 relative to fabrication unit 106 as indicated in a block 408. In the example of FIG. 5A, data acquisition system 104 captures reference image 116A that includes pattern 122A as shown.

Positioning system 110 adjusts a relative position between substrate 120 and fabrication unit 106 as indicated by a block 410. By adjusting the relative position between substrate 120 and fabrication unit 106, positioning system 110 also adjusts the relative position between substrate 120 and data acquisition system 104 because of the fixed position between fabrication unit 106 and data acquisition system 104. In other embodiments or in selected iterations of performing the function of block 410, coarse displacement system 112 adjusts the relative position between substrate 120 and fabrication unit 106 to performed the function of block 410.

In one embodiment, positioning system 110 adjusts the relative position between substrate 120 and fabrication unit 106 by moving substrate 120 relative to data acquisition system 104 and fabrication unit 106 by a small fraction of the step determined in performing the function of block 406. In another embodiment, positioning system 110 adjusts the relative position between substrate 120 and fabrication unit 106 by moving data acquisition system 104 and fabrication unit 106 relative to substrate 120 by a small fraction of the step determined in performing the function of block 406.

Subsequent to adjusting the relative position between substrate 120 and fabrication unit 106, data acquisition system 104 captures a comparison image 116 that includes the target as indicated in a block 412. In the example of FIG. 5B, data acquisition system 104 captures comparison image 116B such that comparison image 116B includes pattern 122A on substrate 120.

Processing system 102 determines a displacement of the target using reference and comparison images 116 as indicated in a block 414. More particularly, displacement module 114 locates the target in reference and comparison images 116. Displacement module 114 calculates the displacement between the relative position of the target in comparison frame 116 with respect to the target in reference frame 116. In the example shown in FIG. 5B, the dashed lines indicate the relative position of pattern 122A in reference image 116A with respect to pattern 122A in comparison image 116B. Displacement module 114 locates pattern 122A in reference image 116A and comparison image 116B and calculates a displacement 514 between the relative position of pattern 122A in comparison image 116B and pattern 122A in reference image 116A.

Processing system 102 adds the displacement to previously calculated displacements as indicated in a block 416. More particularly, displacement module 114 accesses any stored displacements that were calculated in performing previous iterations of the function of block 414 and adds the current displacement to the previous displacements. In the example of FIG. 5B, displacement 514 is the first displacement calculated. Accordingly, displacement module 114 effectively adds displacement 514 to zero and causes this sum to be stored.

A determination is made by processing system 102 as to whether the displacement sum is equal to the step as indicated in a block 418. If the displacement sum is not equal to the step, then the desired step has not been achieved and fabrication system 100 repeats the functions of blocks 410 through 418 until the displacement sum is equal to the step. In the process of repeating the functions of blocks 410 through 418, fabrication system 100 stores comparison image 116 for use as the reference image 116 in the next iteration of performing the function of block 414. Fabrication system 100 also stores the displacement sum for use in the next iteration of performing the function of block 416.

In the example of FIGS. 5A-5D, processing system 102 determines that displacement sum 514 is not equal to the step 500 as shown in FIG. 5B. Accordingly, positioning system 110 adjusts the relative position between substrate 120 and fabrication unit 106 as indicated in block 410, and data acquisition system 104 captures comparison image 116C, shown in FIG. 5C, that includes pattern 122A as indicated in block 412. Displacement module 114 calculates a displacement 524 between the relative position of pattern 122A in comparison frame 116C with respect to pattern 122A in reference frame 116B as indicated in block 414. In the example shown in FIG. 5C, the dashed lines indicate the relative position of pattern 122A in reference image 116B with respect to pattern 122A in comparison image 116C. Processing system 102 adds displacement 524 to previously calculated displacement 514 as indicated in block 416. In block 418, processing system 102 again determines that the displacement sum of displacements 514 and 524 is not equal to step 500 as shown in FIG. 5C.

Referring to FIG. 5D, positioning system 110 again adjusts the relative position between substrate 120 and fabrication unit 106 as indicated in block 410, and data acquisition system 104 captures comparison image 116D that includes pattern 122A as indicated in block 412. Displacement module 114 calculates a displacement 534 between the relative position of pattern 122A in comparison frame 116D with respect to pattern 122A in reference frame 116C as indicated in block 414. The dashed lines in FIG. 5D indicate the relative position of pattern 122A in reference image 116C with respect to pattern 122A in comparison image 116D. Processing system 102 adds displacement 534 to previously calculated displacements 514 and 524 as indicated in block 416. In block 418, processing system 102 determines that the displacement sum of displacements 514, 524, and 534 is equal to step 500 as shown in FIG. 5D.

Once the displacement sum is equal to the step, then the desired step has been achieved and the method continues by repeating the functions of blocks 402 through 418 until there are no other patterns 122 to form. With each iteration of performing the function of block 402, fabrication unit 106 forms a pattern 122 on substrate 120 at a desired step from a previous pattern 122. Accordingly, fabrication unit 106 forms a pattern 122B on substrate 120 at step 500 from previous pattern 122A in the example of FIG. 5D.

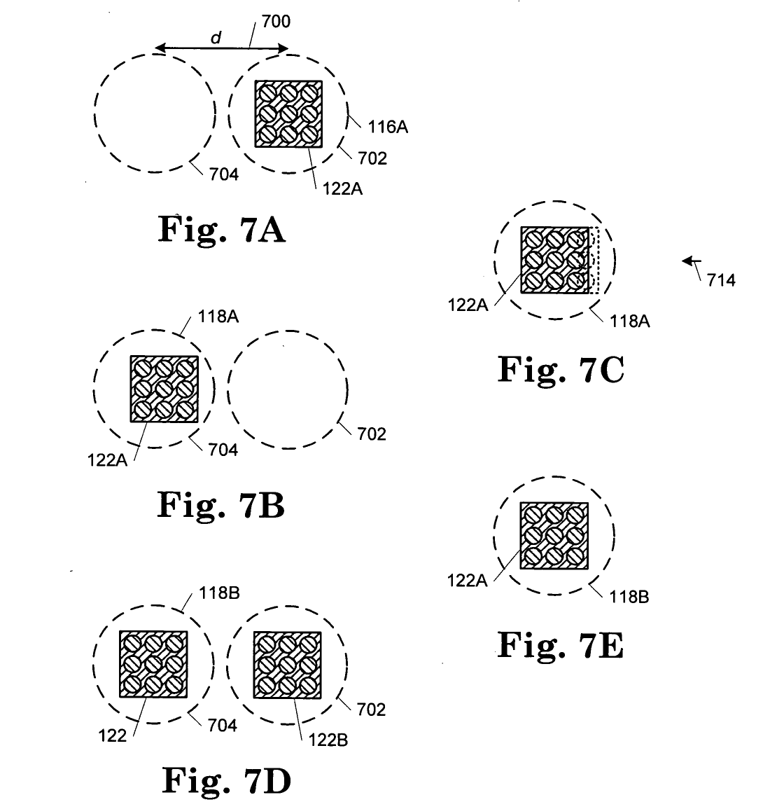

FIG. 6 is a flow chart illustrating one embodiment a method for forming patterns 122 on substrate 120 in fabrication system 100. The method of FIG. 6 will be described with reference to fabrication system 100 as shown in FIG. 1 and examples of a target, i.e., pattern 122A, in reference and comparison images as shown in FIGS. 7A-7E according to one embodiment. The method of FIG. 6 include functions of selected blocks of the method of FIG. 4 as shown.

In the embodiment of FIG. 6 described below, data acquisition system 108 is present and generates comparison images 118. In other embodiments, data acquisition system 108 is not present and data acquisition system 104 includes a large enough field of view to perform the functions of data acquisition system 108 described below. In addition, coarse displacement system 112 is present in the embodiment of FIG. 6.

In FIG. 6, fabrication unit 106 forms a pattern 122 on substrate 120 as indicated in block 402. In the example of FIG. 7A, fabrication unit 106 forms pattern 122A on substrate 120 at a desired location. In other embodiments, pattern 122A may be formed on substrate 120 prior to commencing the method shown in FIG. 6. In these embodiments, the function of block 402 may be skipped in the first iteration of the method.

A determination is made by fabrication system 100 as to whether there is another pattern 122 to form as indicated in block 404. If there is not another pattern 122 to form, then the method ends as shown. If there is another pattern 122 to form, then processing system 102 determines a step for a next pattern 122 as indicated in a block 406. As noted above, the step represents the desired displacement between a current pattern 122 and the next pattern 122. In the embodiment of FIG. 6, the desired displacement is equal to a distance between imaging windows of data acquisition system 104 and data acquisition system 108 or a sub-multiple of the distance. In the example of FIGS. 7A-7E, the step represents the desired displacement between pattern 122A and the next pattern 122B to be formed by fabrication unit 106 and also represents the distance, d, between a window 702 of data acquisition system 104 and a window 704 data acquisition system 108 as by an arrow 700.

Data acquisition system 104 captures a reference image 116 that includes a target on substrate 120 relative to fabrication unit 106 in a first window as indicated in a block 408. In the example of FIG. 7A, data acquisition system 104 captures reference image 116A that includes pattern 122A in a first window 702 as shown.

Positioning system 110 adjusts a relative position between substrate 120 and fabrication unit 106 as indicated by block 410. By adjusting the relative position between substrate 120 and fabrication unit 106, positioning system 110 also adjusts the relative position between substrate 120 and data acquisition system 104 because of the fixed position between fabrication unit 106, data acquisition system 104, and data acquisition system 108. In the embodiment of FIG. 6, positioning system 110 adjusts the relative position between substrate 120 and fabrication unit 106 by a distance equal to the step determined in performing the function of block 406, a sub-multiple of the step, or a correction amount as described in the example of FIGS. 7A-7E below.

In one embodiment, positioning system 110 adjusts the relative position between substrate 120 and fabrication unit 106 by moving substrate 120 relative to data acquisition systems 104 and 108 and fabrication unit 106 by a distance equal to the step determined in performing the function of block 406, a sub-multiple of the step, or a correction amount. In another embodiment, positioning system 110 adjusts the relative position between substrate 120 and fabrication unit 106 by moving data acquisition systems 104 and 108 and fabrication unit 106 relative to substrate 120 by a distance equal to the step determined in performing the function of block 406, a sub-multiple of the step, or a correction amount.

Subsequent to adjusting the relative position between substrate 120 and fabrication unit 106, data acquisition system 108 captures a comparison image 118 that includes the target in a second window as indicated in a block 604. In the example of FIG. 7B, data acquisition system 104 captures comparison image 118A that includes pattern 122A in a second window 704 as shown.

In the process of adjusting the relative position between substrate 120 and fabrication unit 106, coarse displacement system 112 monitors the relative position between substrate 120 and data acquisition systems 104 and 108 to ensures that the second window, e.g., window 704 in FIG. 7B, includes the target, e.g., pattern 122A, when comparison image 118 is captured.

Processing system 102 determines a displacement of the target using reference image 116 and comparison image 118 as indicated in a block 414. More particularly, displacement module 114 locates the target in reference image 116 and comparison image 118, respectively. Displacement module 114 calculates the displacement between the relative position of the target in comparison frame 118 with respect to the target in reference frame 116. In the example shown in FIG. 7B, the dashed lines indicate the relative position of pattern 122A in reference image 116A with respect to pattern 122A in comparison image 118A. Displacement module 114 locates pattern 122A in reference image 116A and comparison image 118A and calculates a displacement 714 between the relative position of pattern 122A in comparison image 118A and pattern 122A in reference image 116A.

Processing system 102 determines a displacement sum as indicated in a block 606. In embodiments where positioning system 110 adjusts the relative position between substrate 120 and fabrication unit 106 by a distance equal to the step in performing the function of block 410, the displacement sum is calculated by adding the displacement determined in block 414 to a distance between data acquisition systems 104 and 108. In these embodiments, the displacement determined in block 414, if non-zero, is a correction amount.

In embodiments where positioning system 110 adjusts the relative position between substrate 120 and fabrication unit 106 by a distance equal to a sub-multiple of the step in performing the function of block 410, the displacement sum is calculated by adding the displacement determined in block 414 to any displacements previously calculated in performing the function of block 414. In these embodiments, the displacement determined in performing the function of block 414, if non-zero, is a correction amount subsequent to the last sub-multiple adjustment, e.g., the third sub-multiple adjustment where the distance is equal to the step divided by three.

A determination is made by processing system 102 as to whether the displacement sum is equal to the step as indicated in block 418. If the displacement sum is not equal to the step, then the desired step has not been achieved and fabrication system 100 repeats the functions of blocks 410 through 418 until the displacement sum is equal to the step. In the process of repeating the functions of blocks 410 through 418, fabrication system 100 either re-uses reference image 116 or stores comparison image 118 for use as the reference image 116 in the next iteration of performing the function of block 414. Fabrication system 100 also stores the displacement sum for use in the next iteration of performing the function of block 606, if necessary.

In the example of FIGS. 7A-7E, processing system 102 determines that displacement sum is not equal to step 700 because displacement 714 represents a non-zero correction amount. Accordingly, positioning system 110 adjusts the relative position between substrate 120 and fabrication unit 106 by the correction amount as indicated in block 410, and data acquisition system 104 captures comparison image 118B, shown in FIG. 7D, that includes pattern 122A as indicated in block 412. Displacement module 114 calculates a displacement between the relative position of pattern 122A in comparison frame 118B with respect to pattern 122A in reference frame 116A as indicated in block 414. In the example shown in FIG. 7E, the relative position of pattern 122A in reference image 116A is identical with respect to pattern 122A in comparison image 118B as indicated by the alignment of patterns 122A. Accordingly, displacement module 114 calculates the displacement as zero and processing system 102 determines that the displacement sum is equal to step 700 in block 606.

Once the displacement sum is equal to the step, then the desired step has been achieved and the method continues by repeating the functions of blocks 402 through 606 until there are no other patterns 122 to form. With each iteration of performing the function of block 402, fabrication unit 106 forms a pattern 122 on substrate 120 at a desired step from a previous pattern 122. Accordingly, fabrication unit 106 forms a pattern 122B on substrate 120 at step 700 from previous pattern 122A in the example of FIG. 7D.

In other embodiments, hybrid methods of the embodiments of the methods shown in FIGS. 4 and 6 may be used. In one embodiment, the method of FIG. 6 may be used to first adjust the relative position between a substrate and a fabrication unit by one or more relatively large distances, and the method of FIG. 4 may then be used to adjust the relative position between a substrate and a fabrication unit by one or more relatively small distances until the desired relative position between the substrate and the fabrication unit are achieved.

Embodiments described herein may provide advantages over previous systems. For example, substrates may be positioned and re-positioned relative to a fabrication unit without the need to overlay patterns on top of each other. In addition, center lines may not need to be calculated. Further, patterns may not need to be symmetric. Still further, systematic errors may be inherently calibrated out.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A method comprising:
capturing a first image that includes a target on a substrate;
adjusting a first relative position between the substrate and a fabrication unit;
capturing a second image that includes the target subsequent to adjusting the first relative position;
determining whether a first displacement of the target in the second image relative to the target in the first image indicates that a second relative position between the substrate and the fabrication unit has been achieved.

2. The method of claim 1 further comprising:
calculating the first displacement of the target in the second image relative to the target in the first image.

3. The method of claim 1 further comprising:
forming a first pattern on the substrate with the fabrication unit in response to determining that the first displacement indicates that the second relative position has been achieved.

4. The method of claim 3 wherein the target comprises a second pattern.

5. The method of claim 3 wherein the target is naturally occurring on the substrate.

6. The method of claim 1 further comprising:
in response to determining that the first displacement indicates that the second relative position has not been achieved:
adjusting a third relative position between the substrate and the fabrication unit using the first displacement;
capturing a third image that includes the target subsequent to adjusting the third relative position;
determining whether a second displacement of the target in the third image relative to the target in the second image indicates that the second relative position between the substrate and the fabrication unit has been achieved.

7. The method of claim 1 further comprising:
adjusting the first relative position between the substrate and the fabrication unit by moving the substrate relative to the fabrication unit.

8. The method of claim 1 further comprising:
adjusting the first relative position between the substrate and the fabrication unit by moving the fabrication unit relative to the substrate.

9. The method of claim 1 further comprising:
capturing the first image and the second image using a data acquisition system that has a fixed position relative to the fabrication unit.

10. The method of claim 1 further comprising:
capturing the first image using a first data acquisition system; and
capturing the second image using a second data acquisition system that has a fixed position relative to the first data acquisition system.

11. A system comprising:
a fabrication unit;
a processing system; and
a positioning system;
wherein the positioning system is configured to adjust a first relative position between a substrate and the fabrication unit, and wherein the processing system is configured to determine whether a first displacement of a target on the substrate captured in a first image prior to the positioning system adjusting the first relative position relative to the target captured in a second image subsequent to the positioning system adjusting the first relative position indicates that a second relative position between the substrate and the fabrication unit has been achieved.

12. The system of claim 11 wherein the processing system is configured to calculate the first displacement of the target in the second image relative to the target in the first image.

13. The system of claim 11 wherein the fabrication unit is configured to form a first pattern on the substrate in response to the first displacement of the target in the second image relative to the target in the first image indicating that the second relative position between the substrate and the fabrication unit has been achieved.

14. The system of claim 13 wherein the target comprises a second pattern.

15. The system of claim 13 wherein the target is naturally occurring on the substrate.

16. The system of claim 11 wherein, in response to determining that the first displacement indicates that the second relative position has not been achieved:
the positioning system is configured to adjust a third relative position between the substrate and the fabrication unit; and
the processing system is configured to determine whether a second displacement of the target captured in a third image subsequent to the positioning system adjusting the third relative position relative to the target in the second image indicates that the second relative position between the substrate and the fabrication unit has been achieved.

17. The system of claim 11 wherein the positioning system is configured to adjust the first relative position between the substrate and the fabrication unit by moving the substrate relative to the fabrication unit.

18. The system of claim 11 wherein the positioning system is configured to adjust the first relative position between the substrate and the fabrication unit by moving the fabrication unit relative to the substrate.

19. The system of claim 11 further comprising:
a first data acquisition system that has a fixed position relative to the fabrication unit and is configured to capture the first image and the second image.

20. The system of claim 11 further comprising:
a first data acquisition system configured to capture the first image; and
a second data acquisition system that has a fixed position relative to the first data acquisition system and is configured to capture the second image.

21. A system comprising:
means for capturing a first image that includes a target on a substrate;
means for adjusting a first relative position between the substrate and a fabrication means;
means for capturing a second image that includes the target subsequent to adjusting the first relative position;
means for determining whether a displacement of the target in the second image relative to the target in the first image indicates that a second relative position between the substrate and the fabrication unit has been achieved.

22. The system of claim 21 further comprising:
means for calculating the displacement of the target in the second image relative to the target in the first image.

23. The system of claim 21 further comprising:
the fabrication means for forming a first pattern on the substrate with the fabrication unit in response to determining that the displacement indicates that the second relative position has been achieved.

24. The system of claim 23 wherein the target comprises a second pattern.

25. The system of claim 23 wherein the target is naturally occurring on the substrate.

26. The method of claim 21 further comprising:
means for adjusting the first relative position between the substrate and the fabrication means by moving the substrate relative to the fabrication means.

27. The method of claim 21 further comprising:
means for adjusting the first relative position between the substrate and the fabrication means by moving the fabrication means relative to the substrate.

28. A computer-readable medium having instructions for causing a processing system to perform a method comprising:
causing a first relative position between a substrate and the fabrication unit to be adjusted; and
determining whether a displacement of a target on the substrate captured in a first image prior to the positioning system adjusting the first relative position relative to the target captured in a second image subsequent to the positioning system adjusting the first relative position indicates that a second relative position between the substrate and the fabrication unit has been achieved.

29. The computer-readable medium of claim 28 having instructions causing the processing system to perform the method comprising:
calculating the displacement of the target in the second image relative to the target in the first image.

30. The computer-readable medium of claim 28 having instructions causing the processing system to perform the method comprising:
causing a pattern to be formed on the substrate in response to the displacement indicating that the second relative position has been achieved.
